(19) United States
(12) Patent Application Publication
(10) Pub. No.: US 2010/0261694 A1
(43) Pub. Date: Oct. 14, 2010

(54) Chemical chaperones and methods of use thereof for inhibiting proliferation of the phytopathogenic fungus Fusarium ssp.

(76) Inventors: Eric Lam, Monroe, NJ (US); Michael Lawton, Highland Park, NJ (US); Hemelatha Seldasan, New Brunswick, NJ (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/755,819

(22) Filed: Apr. 7, 2010

Related U.S. Application Data
(60) Provisional application No. 61/167,258, filed on Apr. 7, 2009.

(51) Int. Cl. A01N 45/00; A01P 3/00

(52) U.S. Cl. 514/182

(57) ABSTRACT

Compositions and methods for preventing fusarium head blight on target crop plants are disclosed.

This application claims priority to U.S. Provisional Application No. 61/167,258 filed Apr. 7, 2009, which is incorporated herein by reference as though set forth in full.

Pursuant to 35 U.S.C. §202(c), it is acknowledged that the U.S. Government has rights in the invention described herein, which was made with funds from the United States Department of Agriculture, Grant Number USWBSI 59-0790-6-063.

### FIELD OF THE INVENTION

The present invention relates to compositions comprising at least one chaperone for use in crop protection and increasing crop yield. More specifically, the invention provides a method of protecting crops against fungal disease and toxins produced thereby by applying such chaperone containing compositions.

### BACKGROUND OF THE INVENTION

Several publications and patent documents are cited throughout this application in order to more fully describe the state of the art to which this invention pertains. The disclosure of each of these citations is incorporated by reference herein.

Fusarium fungal species such as F. graminarium, F. culmorum and F. oxysporum are important pathogens worldwide whose infection can severely damage crops. Fusarium Head Blight (FHB) is a major problem for agriculture which results in loss of yield and the contamination of grains with tricothecene toxins, such as deoxnivalenol (DON, or vomitoxin), 15-acetyl DON and nivalenol [1-4] that pose a serious health threat to animals in addition to serious crop losses. Although precise figures are difficult to establish, it has been estimated that the total cost of contamination of crops with the mycotoxins aflatoxin, fumonisin and DON to the US alone is in the range of $0.5 million to over $1.5 billion (Vardon, quoted in [5]). While screening programs have mitigated the human health consequences of mycotoxin contamination of crops, these problems remain severe in developing countries, where there is no systematic testing of grain lots, prior to consumption and distribution. There is thus a pressing need for compositions and methods that can enhance the resistance of wheat and barley to FHB and prevent the accumulation of DON on these commercially significant crops.

### SUMMARY OF THE INVENTION

In accordance with the present invention, a method for increasing the resistance of a plant or plant cell to a fungus and fungal toxins produced thereby is provided. An exemplary method entails administration of at least one chaperone selected from the group consisting of 4-phenyl butyric acid and tauroursodeoxycholic acid or biologically active derivatives thereof, to the plant or surrounding soil, the chaperone being effective to suppress fungus induced programmed cell death and reducing the elaboration of toxin from said fungus onto the plant. In a preferred embodiment, the plant is wheat or barley and the fungus is a phytopathogenic Fusarium ssp. In a particularly preferred embodiment, the fungus is Fusarium graminearum and the toxin is a tricothecene toxin. Thus, the method of the invention is effective to inhibit colonization of a host plant by said fungus. However, the chaperones employed are not toxic to the plant or fungicidal when added to fungal cultures growing on nutrient plates under sterile conditions. The chaperones can be applied to a variety of plant parts. These include without limitation, leaves, stems, roots, seeds, tubers or bulbs and the like.

In certain embodiments, the chaperone is applied to the soil. Optionally, the soil may be tested for the presence of the fungus prior to cultivation of crop plants therein. In certain embodiments, the chaperone is applied post-harvest to plants and plant parts.

### BRIEF DESCRIPTION OF THE DRAWINGS

FIG. 1. Tunicamycin induced cell death in Physcomitrella patens and its attenuation by chemical chaperones. 20 day-old wild-type Physcomitrella patens gametophore cells are treated with 10 μg/ml tunicamycin for 72h in the presence or absence of 100 μM TUDCA or PBA. a. Bright field microscopy of Physcomitrella gametophore cells showing morphological changes (left hand panels), cell death (center panels) measured by Evans Blue, and reactive oxygen species (ROS) production (right hand panels) detected by DAB staining. Bars=100 μM. b. The gametophore cells were counterstained with DAPI followed by TUNEL reagents and observed by laser confocal fluorescence microscopy. c. Quantitative measurement of cell death. d. ROS (H₂O₂) production. e. Total chlorophyll content in gametophore cells treated with tunicamycin in the presence or absence of chemical chaperones PBA or TUDCA (100 μM). For panels c-e: 1: control, uninoculated plants; 2: plants treated with Tunicamycin; 3: plants treated with Tunicamycin plus PBA; 4: plants treated with Tunicamycin plus TUDCA.

FIG. 2. Tunicamycin induced cell death in Triticum aestivum (wheat) is alleviated by co-treatment with chemical chaperones. 10-day old, wild-type Triticum aestivum leaf segments are treated with 10 μg/ml Tunicamycin for 72h in the presence or absence of 100 μM TUDCA or PBA. a. Bright field microscopy of leaf cells showing morphological changes (left hand panels), cell death (center panels) measured by Evans Blue staining, and ROS production (right hand panels) detected by DAB staining. Bars=100 μM. b. Leaf cells were counterstained with DAPI followed by TUNEL reagents and observed by fluorescence confocal microscope. c. Quantitative measurement of cell death from counting the percentage of Evans Blue stained cells. d. ROS (H₂O₂) production. e. Total chlorophyll content in leaves treated with tunicamycin in the presence or absence of chemical chaperones. For panels c-e: 1: control, uninoculated plants; 2: plants treated with Tunicamycin; 3: plants treated with Tunicamycin plus PBA; 4: plants treated with Tunicamycin plus TUDCA.

FIG. 3. Chemical chaperones attenuated infection and cell death caused by F. graminearum on Physcomitrella patens. Physcomitrella plants were inoculated with F. graminearum:GFP in the presence or absence of 100 μM TUDCA or PBA. a. Confocal fluorescence microscopy of infected Physcomitrella gametophore cells. DIC: Differential Interference Contrast Microscopy reveals the overall structure and location of the plant sample; Autofluorescence reveals red fluorescence due to chlorophyll present in the plant; GFP: epifluorescence reveals green fluorescence due to presence of the F. graminearum:GFP strain; Merge: combines autofluorescence and GFP images. b. Bright field microscopy of Physcomitrella gametophore cells showing morphological changes (Symptoms, left-hand panels), cell death revealed by Evans Blue staining (EB, center panels), and ROS production detected by DAB staining (DAB, right-hand panels). Bars=100 μM. Quantitative measurement of cell death (c), ROS (H₂O₂) production (d) and total chlorophyll content (e) are shown in the bottom panels. For panels c-e: 1: control, uninoculated plants; 2: plants inoculated with F. graminearum; 3: plants inoculated with F. graminearum in the presence of PBA; 4: plants inoculated with F. graminearum in the presence of TUDCA. f. Determination of F. graminearum growth in planta by genomic PCR assay. Physcomitrella plants inoculated with F. graminearum alone or with F. graminearum in presence of chemical chaperones (indicated on the top of the panel by F.g., F.g.+PBA and F.g.+TUDCA, repsectively) were used to prepare DNA for detection of the F. graminearum actin 1 gene (indicated on the left of the panel by F.g) or the Physcomitrella actin gene (indicated on the left of the panel by P.p). g. Fluorescence microscopic images of DAPI- and TUNEL-stained cells, Bars=100 μM. h. Plant gene expression: Physcomitrella plants were inoculated with F. graminearum in the presence or absence of 100 μM TUDCA or PBA. Tissues were collected at the indicated times and RNA was isolated and used for RT-PCR with primers specific for the Physcomitrella genes shown.

FIG. 4. Chemical chaperones attenuated infection and cell death caused by F. graminearum in Triticum aestivum. Wheat leaf segments were inoculated with F. graminearum:GFP in the presence or absence of 100 μM TUDCA or PBA. a. Laser confocal Fluorescence microscopy of infected wheat leaf tissues. DIC: Differential Interference Contrast microscopy reveals the overall structure and location of the plant sample; GFP: epifluorescence reveals green fluorescence due to presence of the F. graminearum:GFP strain; Autofluorescence reveals red fluorescence due to chlorophyll present in the plant; Merge: combines autofluorescence and GFP images. b. Bright field microscopy of wheat leaf segments showing morphological changes, including yellowing (Symptoms, left-hand panels), cell death revealed by Evans Blue staining (EB, center panels), and ROS production detected by DAB staining (DAB, right-hand panels). Bars=100 μM. Quantitative measurement of cell death (c), ROS (H₂O₂) production (d) and total chlorophyll content (e) are shown in the bottom panels. For panels c-e: 1: control, uninoculated plants; 2: plants inoculated with F. graminearum; 3: plants inoculated with F. graminearum in the presence of PBA; 4: plants inoculated with F. graminearum in the presence of TUDCA. f. Determination of F. graminearum growth in planta by genomic PCR assay. Wheat leaf segments were inoculated with F. graminearum alone or with F. graminearum in presence of chemical chaperones (indicated on the top of the panel by F.g., F.g.+PBA and F.g.+TUDCA, repsectively) were used to prepare DNA for detection of the F. graminearum actin 1 gene (indicated on the left of the panel by F.g) or the T. aestivum (wheat) actin gene (indicated on the left of the panel by T.a). g. Fluorescence microscopic images of DAPI- and TUNEL-stained cells, Bars=100 μM. h. Plant gene expression: Wheat leaves were inoculated with F. graminearum in the presence or absence of 100 μM TUDCA or PBA. Tissues were collected at the indicated times and RNA was isolated and used for RT-PCR with primers specific for the genes shown.

FIG. 5. Effect of chemical chaperones on germination of wheat seeds inoculated with Fusarium graminearum. Germinating wheat seeds were inoculated with conidiospores of the fungal pathogen F. graminearum (F.g.) in the presence or absence of 100 μM TUDCA or PBA. A) Progression of infection on seed germination 2 days and 10 days after inoculation. B) Percentage of germinating seedlings exposed to F.g. in the presence or absence of 100 μM TUDCA or PBA. Clear infection and growth of the fungus was observed on inoculated seeds at 10 days, resulting in no obvious germination of the imbibed seeds (F.g. treatment alone) while dramatic suppression of fungal growth and near normal germination of seeds (>75% seeds with emerged shoots) are observed in the presence of F.g. conidiospores when chemical chaperones were added.

FIG. 6. Effect of chemical chaperones on germination and growth of F. graminearum conidiospores. a. Germination and growth of conidiospores of F. graminearum:GFP on solid medium containing 100 μM TUDCA or PBA; b. colony diameter; c. conidiospore germination percentage; d. fluorescence microscopy of cell death detected by staining with Evans Blue and live cells with GFP fluorescence; e. quantitative measurement of cell death in mycelium of F. graminearum. No obvious effect of chemical chaperones on fungal growth is observed.

### DETAILED DESCRIPTION OF THE INVENTION

Fusarium graminearum is the causal agent of head blight in wheat and barley. In addition to causing yield loss in these important crops, infected grain becomes contaminated with tricothecene toxins, which pose a serious threat to human health (1). Infection of the moss Physcomitrella patens and wheat (Triticum aestivum) with F. graminearum was accompanied by plant cell death, ROS production, nuclear fragmentation and callose deposition. In both systems, fungal infection led to the induction of genes associated with ER stress and the unfolded protein responses (UPR). Using two different chemical chaperones, small molecules that can suppress ER stress and the UPR, we show here evidence that ER stress mediates the induction of cell death by F. graminearum and that its suppression provides effective protection against the pathogen and tricothecene toxins. Our results open a novel approach for controlling necrotrophic phytopathogens through the suppression of ER-stress mediated cell death in the host.

### Definitions:

As used herein, a “chaperone” is one of a chemically diverse class of compounds known to increase ER capacity, stabilize protein conformation against denaturation, and/or to facilitate protein folding or re-folding, thereby preserving and/or maintaining protein structure and function (Welch et al. Cell Stress Chaperones 1:109-115, 1996; incorporated herein by reference). In certain embodiments, the “chaperone” is a small molecule or low molecular weight compound, usually an osmolyte. Preferably, the “chaperone” is not a protein. Examples of “chaperones” for use in the invention include, but are not limited to glycerol, deuterated water (D₂O), dimethylsulfoxide (DMSO), trimethylamine N-oxide (TMAO), glycine betaine (betaine), glycerolphosphocholine (GPC) (Burg et al. Am. J. Physiol. (Renal Physiol. 43):F762-F765, 1998; incorporated herein by reference), 4-phenyl butyrate or 4-phenyl butyric acid (PBA), derivatives of 4-PBA such as those described in U.S. Pat. No. 6,372,938, methylamines, ursodeoxycholic acid (UDCA), and tauroursodeoxycholic acid (TUDCA). Derivatives of TUDCA, such as those described in U.S. Pat. No. 5,500,421 are also contemplated for use in the method described herein. Chaperones may be used to influence the protein folding in a cell. Preferred chaperones of the instant invention include compounds that decrease the level of ER stress as determined by a decrease in the level of at least one ER stress marker in cells as compared to the level of the marker in cells prior to exposure to the chemical chaperone.

In general, the “effective amount” of an active agent, such as an ER stress reducer or a composition thereof, refers to the amount of the active agent necessary to prevent fungal growth and toxin elaboration thereby. In certain embodiments, the effective amount of the ER stress modulator reduces the levels of at least one ER stress marker. In certain embodiments, the levels of at least two, three, four, or more ER stress markers are reduced. The ER stress marker may be reduced by approximately 10%, 20%, 30%, 40%, 50%, 60%, 70%, 80%, 90%, 95%, 98%, 99%, or 100%.

“Endoplasmic reticulum (ER) stress inducing agent” as used herein refers to any of a number of chemically diverse compounds that increase the level of stress in the ER as determined by an increase in at least one ER stress marker in cells as compared to the level of the ER stress marker prior to exposure to the ER stress inducing agent. ER stress inducing agents include, but not limited to, thapsigargin, tunicamycin, azetidine-2 carboxylic acid (Azc, a purine analog).

“Endoplasmic reticulum (ER) stress markers” as used herein refers to the hallmarks of ER stress, such as those observed in plant cells infected with fungus as described herein. Markers can be proteins that are modified (e.g., phosphorylated or dephosphorylated) or translocated in response to ER stress. mRNA and/or protein levels, or mRNA splicing may also be altered in response to ER stress resulting in the production of different amounts or isoforms of proteins. Such markers can include, without limitation, Ire1, sHSP, Cnx1, sec61, Derlin1, BI-1 and Bip.

“Target crop” to be protected within the scope of this invention comprise, for example, the following species of plants: cereals (wheat, barley, rye, oats, rice, maize, sorghum and related species); beet (sugar beet and fodder beet); pomes, stone fruit and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucurbitaceae (marrows, cucumbers, melons); fiber plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamon, camphor) and plants such as tobacco, nuts, coffee, sugar cane, tea, pepper, vines, hops, bananas and natural rubber plants, and also ornamentals.

The present method should be effective against a variety of diseases. Examples are head blight, downy mildew, blue mold, leaf spots, fusarium wilt, trunk rot, fruit brown rot, damping off, white rust, black shunk and Phytophthoras root rots.

The chaperones of this invention will typically be applied to crops or their locus before or after the onset or after the initial signs of fungal attack and may be applied to the foliar surfaces of the crop. The amount of the active ingredient to be employed will be sufficient to render the plant resistant to the fungi and will vary depending on such factors as the species of fungi to be controlled, the type of treatment (for example, spraying dusting, seed treatment, soil drench), the condition of the crop, the particular composition of the application formulation such as the surfactant used, and the particular active ingredient used.

As an application to the crop or its locus, the chaperones will be applied to the crops with a dosage rate of from 0.1 to 5 kg/ha, preferably from 0.2 to 2 kg/ha, with application being repeated as necessary, typically at intervals of every one to three weeks.

Depending on circumstances, the chaperones of this invention may be used in association with other pesticides, e.g., fungicides, insecticides, acaricides, herbicides, or plant growth regulating agents in order to enhance their activity or to widen their spectrum of activity.

The chaperones of this invention are conveniently employed as fungicidal compositions in association with agriculturally acceptable carriers or diluents although they do not possess fungicidal activity per se. Such compositions also form part of the present invention. They may contain, aside from the chaperones described above as active agent, other active agents, such as fungicides. They may be employed in either solid or liquid application forms e.g., in the form of a wettable powder, an emulsion concentrate, a water dispersible suspension concentrate (“flowable”), a dusting powder, a granulate, a delayed release form incorporating conventional carriers, diluents and/or adjuvants. Such compositions may be produced in conventional manner, e.g. by mixing the active ingredient with a carrier and other formulating ingredients.

Particular formulations to be applied in spraying forms such as water dispersible concentrates or wettable powders may contain surfactant such as wetting and dispersing agents, e.g., the condensation product of formaldehyde with naphthalene sulphonate, an alkyl-aryl-sulphonate, a lignin sulphonate, a fatty alkyl sulphate an ethoxylated alkylphenol and an ethoxylated fatty alcohol.

In general, the formulations include from 0.01 to 90% by weight of active chaperone agent, said active agent consisting either of at least one chaperone or mixture thereof with other active agents, such as fungicides. Concentrate forms of compositions generally contain between about 2 and 80%, preferably between about 5 and 70% by weight of chaperone. Application forms of formulation may, for example, contain from 0.01% to 20% by weight, preferably from 0.01% to 5% by weight, of chaperone.

### Formulation Example I: Wettable Powder

50 parts by weight of a compound of 4-PBA or TUDCA or derivatives thereof are ground with 2 parts of lauryl sulphate, 3 parts sodium lignin the sulphonate and 45 parts of finely divided kaolininite until the mean particle size is below 5 microns. The resulting wettable powder so obtained is diluted with water before use to a concentration of between 0.01% to 5% active ingredient. The resulting spray liquor may be applied by foliar spray as well as by root drench application.

### Formulation Example II: Emulsion Concentrate

25 parts by weight of a 4-PBA or TUDCA or derivatives thereof, 65 parts of xylene, 10 parts of the mixed reaction product of an alkylphenol with xyleneoxide and calcium-dodecyl-benzene sulphonate are thoroughly mixed until a homogeneous solution is obtained. The resulting emulsion concentrate is diluted with water before use.

### Formulation Example III: Granulate (for Soil Treatments)

Onto 94.5 parts by weight of quartz sand in a tumbler mixer is sprayed 0.5 parts by weight of a binder (non-ionic tenside) and is thoroughly mixed. 5 parts by weight of 4-PBA or TUDCA or derivatives thereof in powdered form are then added and thoroughly mixed to obtain a granulate formulation with a particle size in the range of from about 0.3 to about 0.7 mm. The granulate may be applied by incorporation into the soil adjacent the plants to be tested.

### Formulation Example IV: Seed or Tuber Dressing

25 parts by weight of 4-PBA, TUDCA or derivatives thereof and 15 parts of dialkylphenoxy-poly-(ethylenoxy) ethanol, 15 parts of fine silica, 44 parts of fine kaolin, 0.5 parts of a colorant (e.g., crystal violet) and 0.5 parts of xantham gum are mixed and ground in a contraplex mill at approximately 10,000 rpm to an average particle size of below 20 microns.

The resulting formulation is applied to the seeds or tubers as an aqueous suspension in an apparatus suitable for that purpose. Where the chaperone is liquid, it is first absorbed on the carriers, if desired with the air of a small amount of a volatile solvent such as acetone. The resulting powder is first allowed to dry if a solvent is used, then the other ingredients are added and the rest of the procedure is carried out.

### Formulation Example V: Soil Drench Drip Irrigation

2 parts by weight of the chaperone (e.g., 4-PBA) are dissolved in 1,000 parts of water. The resulting formulation is applied to plants by drip irrigation.

### Formulation Example VI: Post-Harvest Protection of Plants.

Harvested plants or plant parts (seeds, grain, fruit, vegetables, roots, tubers) are sprayed or dipped in a solution containing 2 parts by weight of 4-PBA or TUDA in 1,000 parts of water.

The following materials and methods are provided to facilitate the practice of the invention. They are not intended to limit the invention in any way.

### Growth Conditions and Treatments

Physcomitrella patens W T Grandsden is used for the experiments. Wild type P. patens was grown on solid minimal medium 41 at 25° C. with a photoperiod of 16 h light and 8 h darkness and was subcultured every week. For our experiments 20 day old plants with mature gametophore were used. The gametophores were treated with Tunicamycin (Sigma-Aldrich) 10 μg/ml (from 0-72 h) or co-treated with either 100 μM PBA or TUDCA to evaluate the effect of chemical chaperones in water. The WT Fusarium graminearum (GFP) strain was used to infect both protonema and gametophore. Plants were inoculated with conidiospores in water and sampled at 0, 24, 48 and 72 and 96 h post treatment. The ten days old wheat seedlings were used for the above mentioned treatments and the cut leaves (ref) were used to see the effect of Tunicamycin treatment and Fusarium inoculation.

### Histochemistry and Microscopy

The changes in phenotype and cell death were observed by Zeiss Axiovert 200 inverted microscope with epifluorescence setting. The digital images were acquired with Zeiss Axioxam digital camera and software for image archival and management (Axiovision 3.0; Carl Zeiss Vision GmbH). Cell death in plants was detected with 0.05% Evan's blue staining 42, 43. Briefly, the plant samples at different time points were treated with 0.05% Evans blue for 30 minutes and then washed with water to remove the excess stain. The stained cells were counted and plotted. Each time point represents an average of 3 independent experiments. Gametophore cells and wheat seedlings were stained with 6-diamidino-2-phenylindole (DAPI) to detect nuclear fragmentation. The gametophores cells and wheat leaf pieces were stained with DAPI to detect the chromatin condensation and nuclear fragmentation for 10 minutes and washed with water to remove the excess dye. The nuclei were observed under a fluorescence microscope (model Zeiss Axiovert 200 inverted microscope with epifluorescence setting.) using UV excitation (330-385 nm) for DAPI. The digital images were acquired with Zeiss Axioxam digital camera and software for image archival and management (Axiovision 3.0; Carl Zeiss Vision GmbH). The production of reactive oxygen species (ROS) was detected by diaminobenzidine (DAB 1 mg/ml) staining described by 44 and observed under light microscope described above.

### Hydrogen Peroxide Production

Hydrogen peroxide release was measured 46, 47 in control and elicitor treated plants at the indicated time points. The assay is based on a colorimetric reaction with Xylenol orange. 1 ml of assay solution was added to control and treated cells and the absorbance was measured 45 minutes after incubation at 560 nm.

### Genomic PCR

Genomic DNA was isolated from P. patens and T. aestivum by CTAB method (48) and used for genomic PCR.

### RT-PCR

Total RNA was extracted using plant RNA reagent (Invitrogen, USA) and followed the manufacturer's protocol. The cDNA was synthesized (Invitrogen, RT kit, USA) and used as a template to amplify the interested genes. Gene specific sequences of oligonucleotides were used to amplify Physcomitrella patens gene transcripts encoding the following genes (primers to be added)

### Measurement of Chlorophyll

Total chlorophyll content was estimated spectrophotometrically (49).

The following examples are provided to illustrate certain embodiments of the invention. They are not intended to limit the invention in any way.

### EXAMPLE I

### Chaperones and Uses Thereof to Inhibit Fungal Proliferation on Crop Plants

Breeding has provided the most effective means to increase resistance to FHB to-date and there is a substantial effort to identify and incorporate QTLs associated with FHB resistance into breeding programs [11, 12]. However the sources of germplasm effective against FHB are limited for both wheat and are almost non-existent for barley [1, 13]. Babaeizad et al. (Theor. Appl. Genet. 118:455-463 (2009)) has reported that overexpression of a highly conserved cell death suppressor, Bax Inhibitor-1 (BI-1), in barley can lead to decreased susceptibility to F. graminearum. Recently, our genetic and pharmacological studies in the model plant Arabidopsis thaliana have identified a link between the endoplasmic recticulum (ER) stress pathway and the cell death inhibitory function of BI-1 in plants. In view of these results, we hypothesize that necrotrophic pathogens such as F. graminearum may activate cell death of the host through the ER stress pathway and as such, suppression of this host signaling system may provide a novel strategy for fungal resistance.

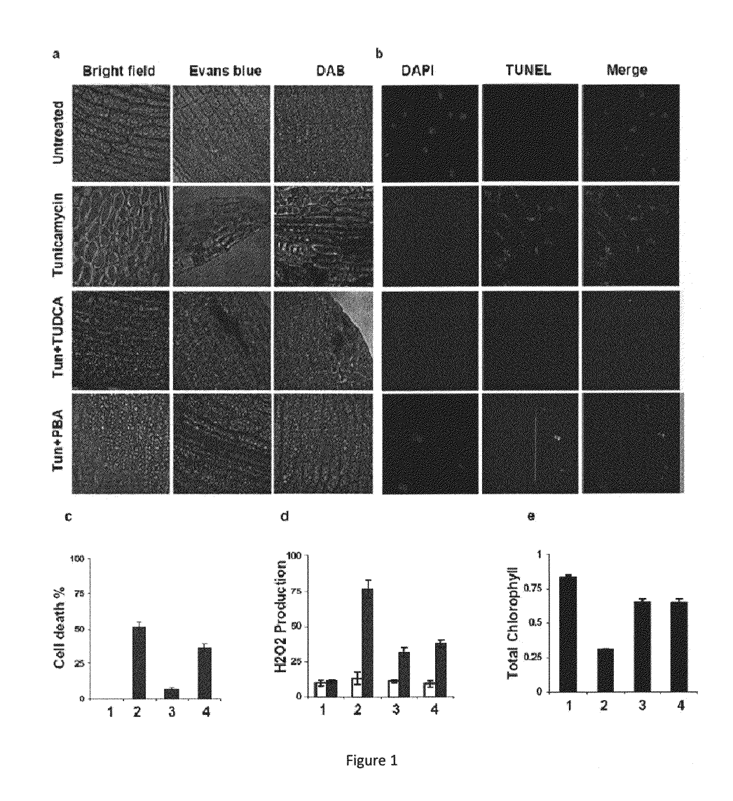

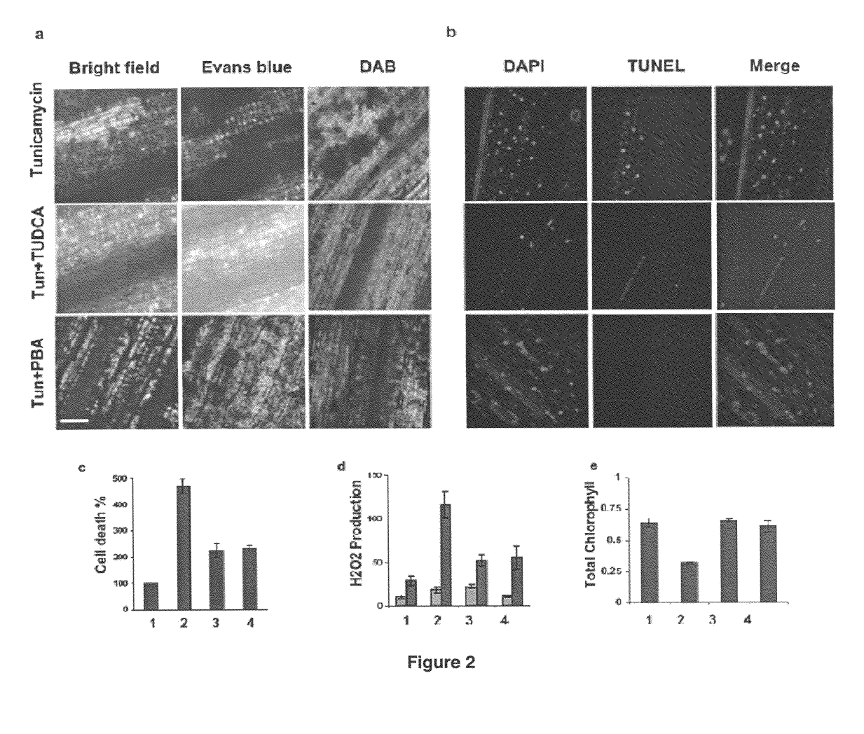

To test these hypotheses, we first examined the degree of conservation of the ER stress response phenomenon in wheat and moss, as compared to our previous work with Arabidopsis. We chose the moss P. patens for our study in parallel with wheat since it provides a convenient in vitro system for our studies, in addition to the evolutionary distance of over 400 million years for this bryophyte from angiosperms. ER-stress was induced in P. patens and T. aestivum seedlings by treatment with Tunicamycin, a protein glycosylation inhibitor that is commonly used to induce the Unfolded Protein Response (UPR) signaling pathway associated with ER stress in eukaryotes. 20 day-old Physcomitrella (FIG. 1) and 10 day-old wheat plants (FIG. 2) were transferred into water with or without Tunicamycin and then incubated for 3 days. Upon Tunicamycin addition, Physcomitrella cells showed shrunken cytoplasmic contents with chloroplasts fused together and formed larger pale organelles after 24 h (FIG. 1a). In wheat, Tunicamycin-treated seedlings showed chlorotic leaves (FIG. 2a). The viability of cells treated with Tunicamycin was assessed with Evans Blue (EB) staining which revealed that Tunicamycin treated plants showed more cell death in both plant models compared to untreated control (FIGS. 1a, 1c and 2a, 2c). Previous study [8] has demonstrated that chemical chaperones, small osmolytes that help stabilize protein conformations, such as tauroursodeoxycholic acid (TUDCA) and 4-phenylbutyric acid (PBA) can alleviate the ER stress induced by Tunicamycin in Arabidopsis.

To determine whether Tunicamycin treatment of wheat and moss plants indeed activate ER stress, the effects of co-treatment with TUDCA and PBA were also examined. With either chemical chaperones, we found that their addition attenuated the Tunicamycin induced cell death in both moss and wheat (FIGS. 1, 2), thus providing evidence that inhibition of protein glycosylation results in protein mis-folding and subsequent ER stress-mediated cell death.

To study the ER stress-activated cell death pathway in these two plant models, we examined other cellular characteristics in response to Tunicamycin treatment in moss and wheat. Reactive oxygen species (ROS) are thought to be involved in signaling for various forms of programmed cell death (PCD) in animal and plant cells. Previous studies have indicated that ROS might be important mediators of PCD [15] and may function as part of a signal transduction pathway leading to the induction of defense related genes [16]. DAB staining showed the accumulation of hydrogen peroxide (H₂O₂) with Tunicamycin treated cells which is correlated with cell death. The production of H₂O₂ is also quantified by calorimetric method using Xylenol orange. H₂O₂ production accumulates over time after treatment (only 0 and 24 h are represented in FIGS. 1a, d and 2a, d) and is directly proportional to the ROS production stained with DAB. These results suggest that Tunicamycin-induced cell death involves the production of ROS in moss and wheat.

Nuclear fragmentation is one of the hallmarks of apoptosis in animal cells [17], and it has also been widely reported in plant PCD and in yeast apoptosis. In moss and wheat, we detected DNA fragmentation via the TUNEL assay in plants treated with Tunicamycin. In control cells without Tunicamycin treatment, no TUNEL positive cells were observed (FIGS. 1b and 2b). In plant tissues exposed to Tunicamycin for 24 h, many nuclei appeared TUNEL-positive. The morphological change in the nuclei was also observed with DAPI staining. In control tissues, chromatin is localized throughout the nuclei. Whereas with Tunicamycin treated cells, chromatin was more condensed and exhibited various sizes and shapes (24 h) followed by complete degradation of the nuclei at 72 h post-treatment in both moss and wheat tissues (data not shown). Co-treatment of Tunicamycin and chemical chaperones attenuated ROS production and DNA fragmentation in moss and wheat tissues, indicating that suppression of ER stress can attenuate cell death activation by Tunicamycin in plants. Consistent with this conclusion, the total chlorophyll content is drastically reduced in Tunicamycin-treated plants and is mostly suppressed by co-treatment with chemical chaperones (FIG. 1e and FIG. 2e). Together, these results provide strong evidence that ER stress in both moss and wheat, like the case of Arabidopsis, can lead to PCD activation with classic cellular hallmarks. Furthermore, our observations with the two chemical chaperones suggest the sensitivity of a PCD pathway to these two different compounds could be a good indicator for the involvement of ER stress signaling.

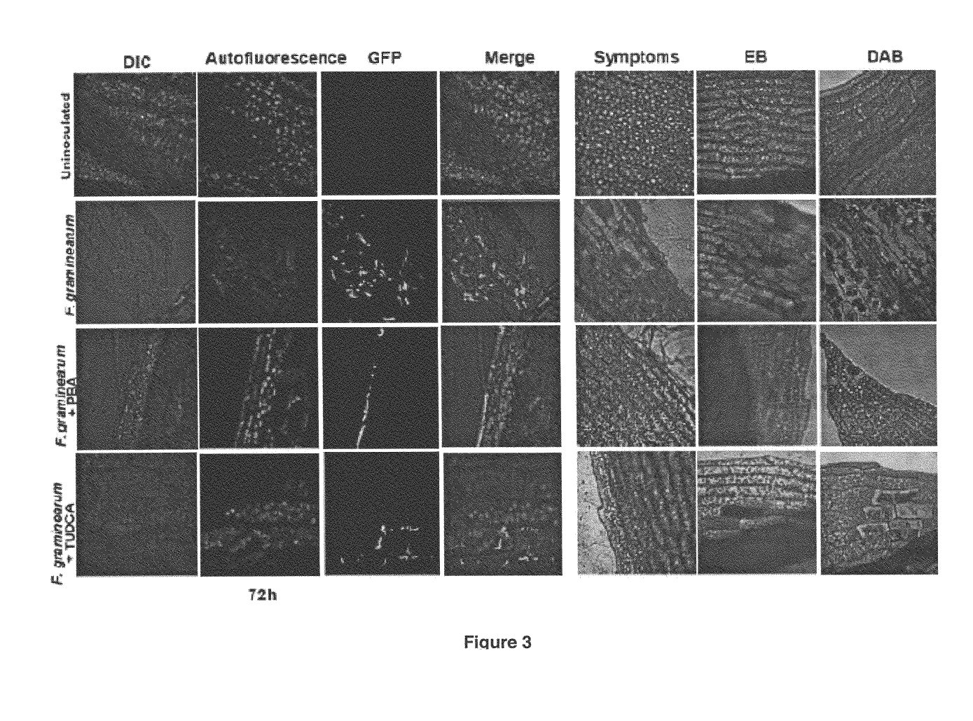

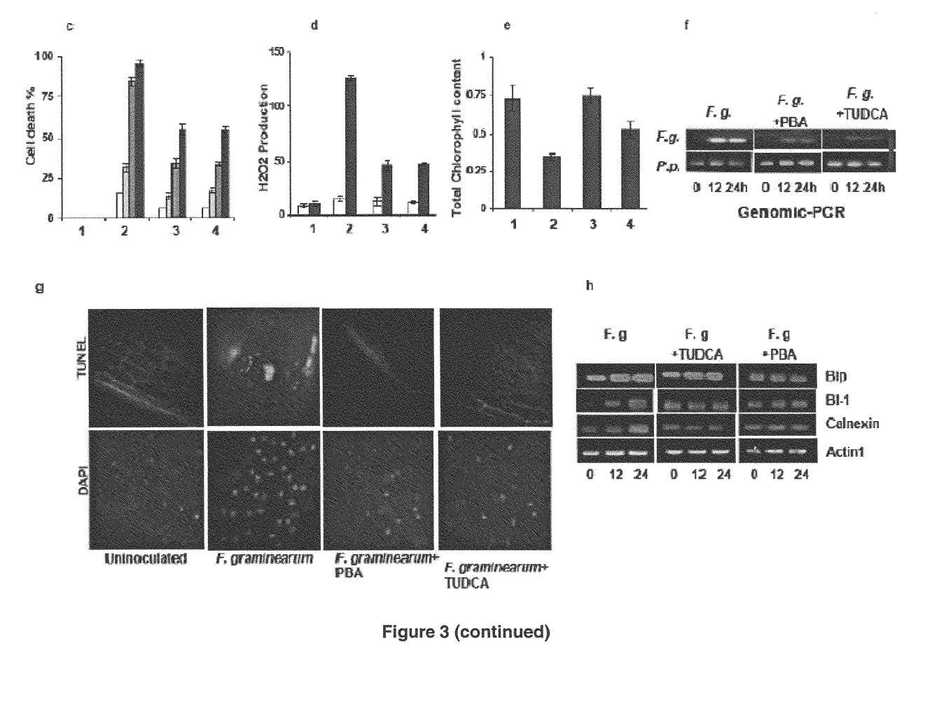

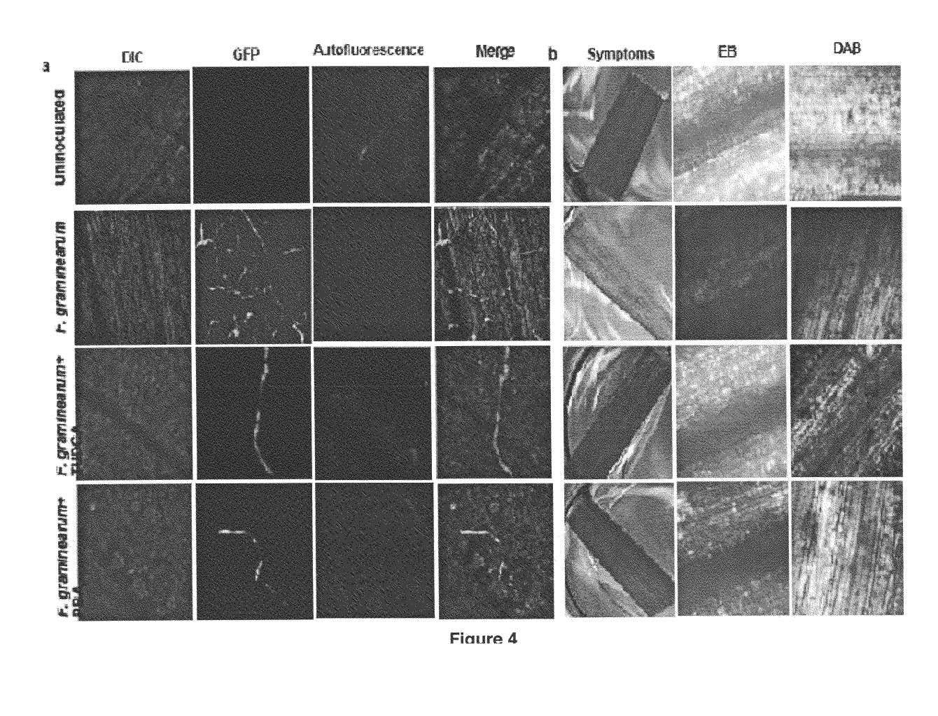

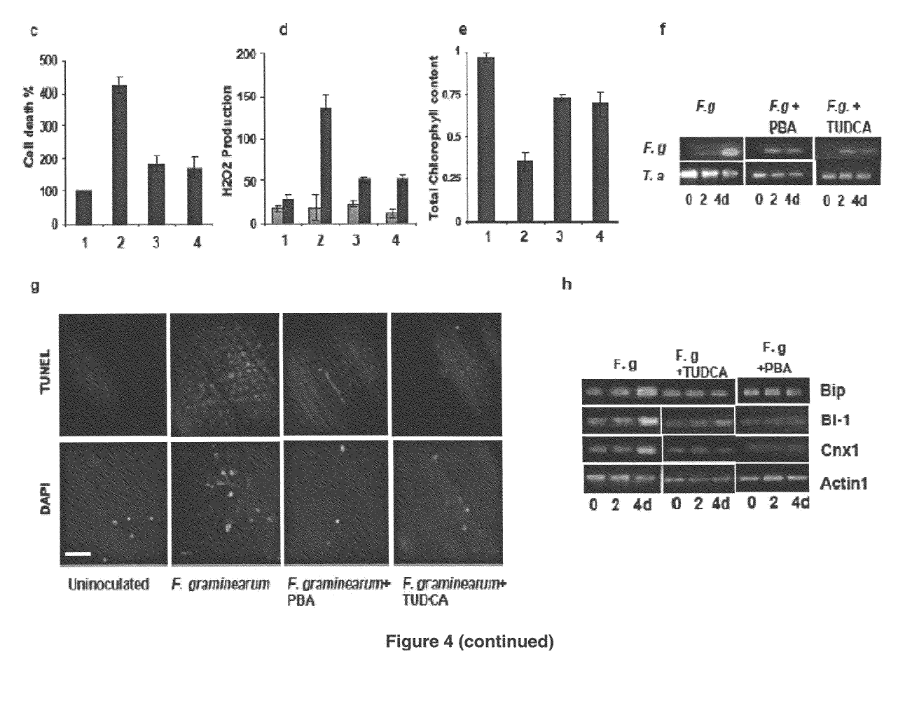

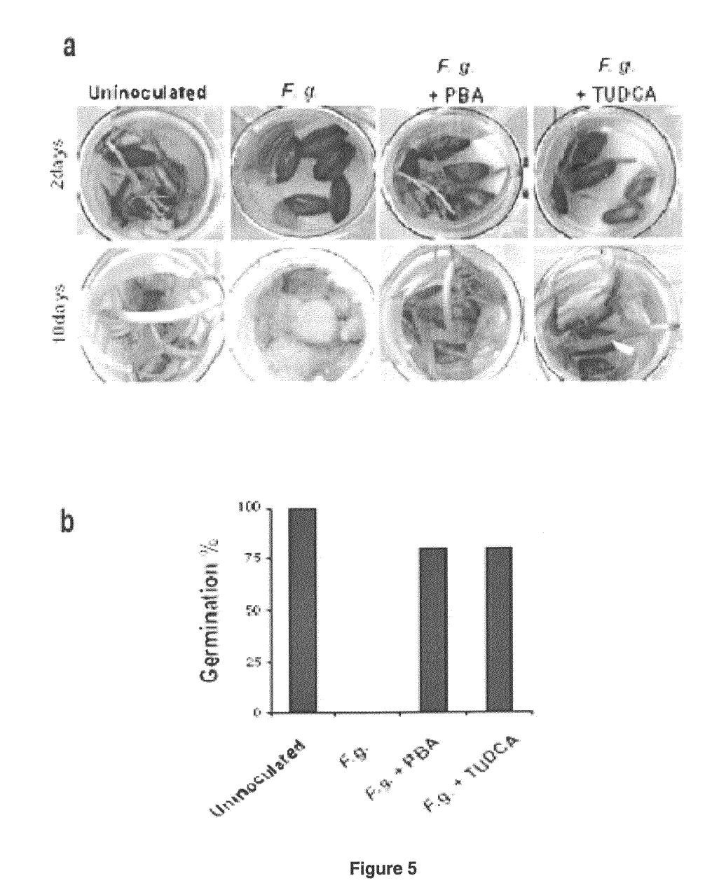

We next addressed the question of whether F. graminearum induced cell death via necrosis or programmed cell death in moss and wheat. Although wheat is a natural host for this necrotrophic fungus, infection response between F. graminearum and Physcomitrella has not been reported previously. FIGS. 3 and 4 compared the infection characteristics of F. graminearum conidiospores at the end of their most extensive growth phase on moss (gametophore cells) and wheat (leaf discs) plant tissues, respectively. Proliferation of the fungal hyphae is visualized via the use of a F. graminearum strain that is tagged with an expressed Green Fluorescent Protein (GFP) marker. Conidiospores began to germinate 24 hr after inoculation and surrounding cell clusters were visible at 48h. Starting from around 24 hr after inoculation, chlorophyll degradation was observed, which was accompanied by fungal proliferation and cell death in both plant systems (FIGS. 3a,b and 4a,b). Changes in cell morphology were associated with increased cell death as measured by Evans Blue-positive cells (FIGS. 3b,c and 4b,c). The difference between the inoculated and control cells became clear after 24 h. This 24 h period could either correspond to the time needed for cells to respond or to the time needed by the fungus to reach a critical level necessary to elicit the response of host cells. To address whether F. graminearum induced cell death involves the production of ROS, we have stained the cells with DAB and also quantified the ROS production colorimetrically. We detected the production of ROS with F. graminearum infection of both moss and wheat tissues (FIGS. 3b, d and 4b, d). In sum, inoculation of moss and wheat tissues with F. graminearum leads to cell death activation as indicated by chlorosis (FIGS. 3e and 4e), Evans Blue-positive staining and ROS generation, concomitant with proliferation of the fungus (FIGS. 3 and 4). Similar to the case of Tunicamycin treatment, DAPI staining of moss and wheat tissues showed the changes in nuclear morphology, chromatin condensation and nuclear DNA fragmentation. As shown in FIG. 3g and FIG. 4g, nuclei in the F. graminearum infected tissues are more brightly stained compared to control uninoculated tissues. There are also more TUNEL-positive cells in plants infected with F. graminearum, which corresponded to nuclei showing condensed chromatin with bright DAPI fluorescence (FIGS. 3g and 4g). These results show that F. graminearum infection induced programmed cell death in wheat and moss tissues. To further test the efficacy of these chemical chaperones on F. graminearum infection of wheat, we have also examined their effects on a seed germination assay (FIG. 5). Imbibed wheat seeds inoculated with F. graminearum conidiospores are completely suppressed in their shoot emergence under our assay conditions with dramatic growth of the fungus observed after 10 days postinoculation. In the presence of either PBA or TUDCA, great than 75% of wheat seedling emergence was observed with concomitant suppression of fungal growth (FIG. 5). These results show that the attenuation of fungal proliferation on wheat by chemical chaperone addition can be observed with different tissues and developmental stages.

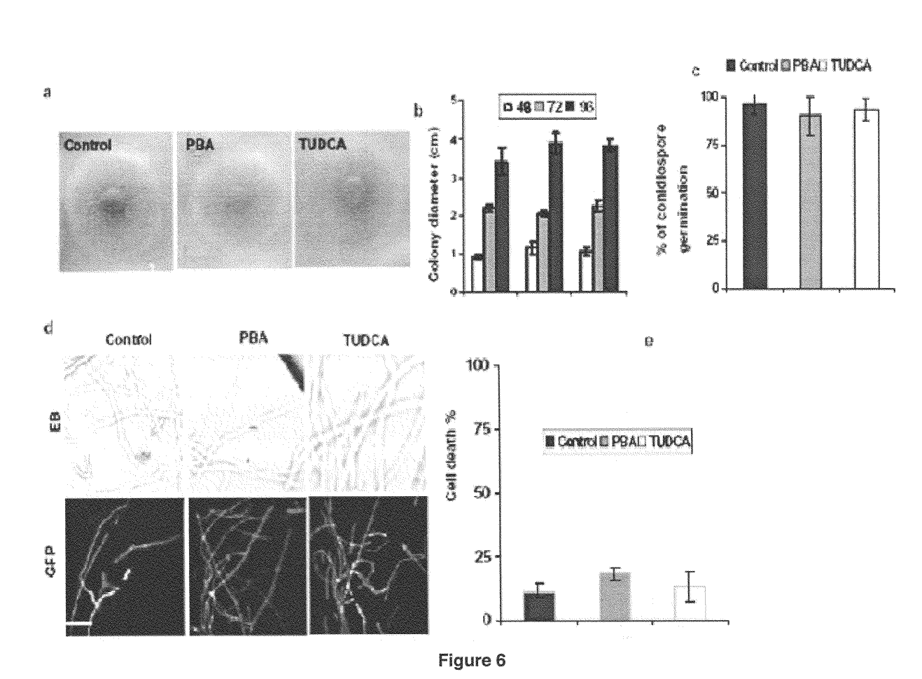

To determine if ER stress mediates this induction and if this host cell death is critical for fungal proliferation, we tested the effects of the two chemical chaperones, PBA and TUDCA, on the interaction between F. graminearum and these two plant models. Remarkably, we found that addition of the two chemical chaperones can significantly suppress the proliferation of F. graminearum on both moss and wheat tissues, as indicated by the low number of GFP-tagged fungal cells (FIGS. 3a and 4a) and a reduction in the amount of fungal RNA that can be detected by RT-PCR amplification from infected tissues (FIGS. 3f and 4f). Moreover, cell death markers such as chlorosis, TUNEL-positive nuclei, Evans Blue staining and ROS induction by the fungal pathogen are all attenuated in the presence of the two compounds (FIGS. 3 and 4). These results thus indicate that the ER stress signaling pathway is used by F. graminearum to induce PCD in two very different host plants and this cell death activation is critical for optimum growth of the fungus. As a control, we tested for a direct effect of the chemical chaperones on the growth of F. graminearum when it is grown on rich medium. We found that the presence of 100 μM PBA or TUDCA did not affect fungal growth and reproduction on solid growth medium (FIG. 6). Thus, suppression of F. graminearum proliferation on the host by these compounds is not due to inhibition of fungal targets.

To gain more insight to the interplay between the fungal pathogen and the host UPR pathway, we have examined changes in steady state transcript levels for UPR pathway related genes. We have observed the induction of several UPR related genes (Ire 1, sHSP, Cnx1, sec61, Derlin1, BI-1 and Bip) from 12-24 hr post-infection in F. graminearum treated moss and wheat plants (FIGS. 3h and 4h). In plants co-treated with the 2 chemical chaperones, the induction of these transcripts by F. graminearum was attenuated and their levels remained at the basal level. This observation is consistent with our conclusion that successful colonization of the host plant by F. graminearum infection is mediated by the induction of UPR in the host that leads to ER stress-mediated PCD induction. Suppression of the UPR/ER stress pathway by the chemical chaperones is thus likely due to blocking the fungus at the PCD signaling step in the host during its infection process.

Chemical or pharmaceutical chaperones, such as PBA and DMSO, are a group of low molecular weight osmolytes that can stabilize protein confirmation and improve their folding capacity in the ER27. Similarly, endogenous bile acids and derivatives such as ursodeoxycholic acid and its taurine-conjugated derivative (TUDCA) can also modulate the ER stress pathway [28]. In this work, we established that pharmacologically active small-molecule chemical chaperones could alleviate the ER stress and associated PCD induced by tunicamycin and F. graminearum on diverse plant species. Numerous studies in animal systems demonstrated that UPR activation and impaired ERAD (ER associated degradation) function might contribute to a variety of diseases including diabetes, Alzheimer's disease, Parkinson disease, cancer and ischemia [10]. Chemical chaperones such as PBA and TUDCA treatments can enhance ER functional capacity and alleviate ER stress in vivo and in vitro [11, 12]. It has also been shown that these chemical chaperones have favorable in vivo safety profiles and have been approved by the FDA in the U.S. for clinical use in urea-cycle disorders as an ammonia scavenger. Some of these compounds have been used in clinical trials for the treatment of other diseases such as thalassemia, cystic fibrosis and cholestatic liver diseases [13,40]. Our present work demonstrates that ER stress-mediated PCD is a key step in pathological interaction between necrotrophic fungal pathogens and their host. Attenuation of this step in the infection process by chemical chaperones can thus prevent disease in plants, in this case FHB, without treatment with a biocidal fungicide. Our present results thus provide an example for the successful translation of basic knowledge gained from studies with model plants such as Arabidopsis thaliana and Physcomitrella patens to cereals for insight into the molecular basis of plant-F. graminearum interaction and identification of promising lead compounds for tackling this important plant disease. In addition, our results suggest that the modulation of ER stress could be a novel target for prevention and treatment of necrotrophic fungal pathogens.

### EXAMPLE II

Fusarium infects wheat and barley heads and damages and contaminates the grain. Consequently, chaperones can be applied during head maturation and grain fill. For example, chaperones, in one of the formulations described above, can be applied by spraying the crop using conventional farming equipment used for pesticide or herbicide application. Protection would be monitored by assaying for a reduction in: (i) symptoms (head scab in wheat and barley), (ii) the presence of F. graminearum, monitored by PCR or immunoassay: (iii) the amount of mycotoxins present in harvested grain, assayed by immunoassay or by conventional HPLC methods. Depending on the infection load, there may be a need for multiple sprayings to protect the crop.

### EXAMPLE III

Grain, fruit, vegetables, roots or other consumable plant parts can be treated with chaperones, post-harvest, to prevent losses due to necrotrophic fungi that are either present in the field, or that become established during harvesting, processing shipping and storage. Spraying or dipping the plants after washing using one of the formulations described above would prevent plant cell death and provide protection against fungal pathogens.

### REFERENCES

1. Schroder, M & Kaufman, R. J. The mammalian unfoled response. Annu Rev Biochem, 74, 739-789 (2005).
2. Ellgaard, L. & Helenius, A. ER quality control: towards an understanding at the molecular level. Curr Opin Cell Biol 13, 431-437(2001).
3. Schrag, J. D, Procopio D. O, Cygler M, Thomas D. Y & Bergeron J. J. M. Lectin control of protein folding and sorting in the secretory pathway. TIBS 28, 49-57(2003).
4. Ma, Y, & Hendershot, L. M. The role of the unfolded protein response in tumorigenesis: friend or foe? Nature Reviews Cancer 4, 966-977, (2004)
5. Noh, S. J, Kwon, C. S, & Chung, W. I Characterization of two homologs of Ire1p, a kinase/endonuclease in yeast, in Arabidopsis thaliana. Biochim Biophys Acta 1575, 130-134, (2002).
6. Back, S. H, Schröder, M, Lee, K. Zhang, K, & Kaufman R. J ER stress signaling by regulated splicing: IRE1/HAC1/XBP1. Methods. 35, 395-416, (2005).
7. Iwata, Y., & Koizumi, N. An Arabidopsis transcription factor, AtbZIP60, regulates the endoplasmic reticulum stress response in a manner unique to plants. Proc. Natl. Acad. Sci. USA 102, 5280-5285, (2005).
8. Watanabe N, & Lam E. BAX inhibitor-1 modulates endoplasmic reticulum stress-mediated programmed cell death in Arabidopsis. J. Biol. Chem. 283:3200-3210, (2008).
9. Zuppini. A, Baldan. B, Millioni R, Favaron. F, Navazio. L & Mariani. P. Chitosan induces Ca2+-mediated programmed cell death in soybean cells. New Phytologist 161: 557-568, (2003)
10. D. Ron & P. Walter, Signal integration in the endoplasmic reticulum unfolded protein response, Nat. Rev. Mol. Cell Biol. 8, 519-529, (2007).
11. Ozcan. U, Yilmaz, E, Ozcan. L, Furuhashi. M, Vaillancourt, E, Smith, R. O, Gorgun C. Z, & Hotamisligil, G. S. Science 313, 1137-1140, (2006).
12. Choi S E, Lee Y J, Jang H J, Lee K W, Kim Y S, Jun H S, Kang S S, Chun J, & Kang Y. A chemical chaperone 4-PBA ameliorates palmitate-induced inhibition of glucosestimulated insulin secretion (GSIS). Arch Biochem Biophys. 475, 109-14, 2008.
13. W. Y. Chen, E. C. Bailey, S. L. McCune, J. Y. Dong & T. M. Townes, Reactivation of silenced, virally transduced genes by inhibitors of histone deacetylase, Proc. Natl. Acad. Sci. USA 94, 5798-5803, (1997).
14. Ward, T. J, Clear, R. M, Rooney, A. P, O'Donnell, K, Gaba, D, Patrick, S, Starkey, D. E, Gilbert, J, Geiser, D. M & Nowicki, T. W. An adaptive evolutionary shift in Fusarium head blight pathogen populations is driving the rapid spread of more toxigenic Fusarium graminearum in North America. Fungal Genetics and Biology 45, 473-484. (2008).
15. Yoshioka H, Numata N, Nakajima K, Katou S, Kawakita K, Rowland O, Jones J D & Doke N Nicotiana benthamiana gp91phox homologs NbrbohA and NbrbohB participate in H₂O₂ accumulation and resistance to Phytophthora infestans. Plant Cell 15, 706-718 (2003)
16. Vandenabeele, P, Berghe, T. V, & Festjens. N Caspase Inhibitors Promote Alternative Cell Death Pathways. Sci. STKE, 24, 358, (2006).
17. Wyllie, A. H, Kerr, J. F & Currie, A. R. Cell death: the significance of apoptosis. International Review of Cytology. 68, 251-306, (1980).
18. Fojtová M, & Kova\check{r}ik A. Genotoxic effect of cadmium is associated with apoptotic changes in tobacco cells. Plant, Cell and Environment. 23, 531-537(2000)
19. Kuthanova, A, Opatrny, Z, & Fischer, L. Is internucleosomal DNA fragmentation an indicator of programmed death in plant cells? J Exp Bot. 59, 2233-40, (2008).
20. Stanghellini, M. E., Rasmussen, S. L., & Vandemark, G. J. Relationship of callose deposition to resistance of lettuce to Plasmopara lactucae-radicis. Phytopathology, 83, 1498-1501, (1993).
21. Kobayashi, Y., Kobayashi, I., Funaki, Y., Fujimoto, S., Takemoto, T., & Kunoh, H. Dynamic reorganization of microfilaments and microtubules is necessary for the expression of non-host resistance in barley coleoptile cells. Plant. J. 11, 525 537. (1997).
22. Koizumi, N, Martinez, I. M, Kimata, Y, Kohno, K, Sano, H, & Chrispeels, M. J. Molecular characterization of two Arabidopsis Ire1 homologs, endoplasmic reticulum located transmembrane protein kinases. Plant Physiol. 127, 949-62. (2001).
23. Sparvoli F, Faoro F, Daminati M G, Ceriotti A, & Bollini R. Misfolding and aggregation of vacuolar glycoproteins in plant cells. Plant J. 24, 825-36, (2000).
24. Foyer, C. H, & Noctor, G. D. Redox Regulation in Photosynthetic Organisms: Signaling, Acclimation, and Practical Implications. Antioxid Redox Signal. 11, 861-905, (2009).
25. Irsigler A. S. T, Costa M. D. L, Zhang. P, Reis. P. A. B, Dewey. R. E, Boston. R. S, & Fontes E. P. B. Expression profiling on soybean leaves reveals integration of ER and osmotic-stress pathways. BMC Genomics 2007, 8:431, (2007).
26. Garcia-Heredia, J. M, Hervás, M, De la Rosa, M. A, & Navarro, J. A. Acetylsalicylic acid induces programmed cell death in Arabidopsis cell cultures. Planta, 228, 89-97 (2008)
27. Welch W J, & Brown C R. Influence of molecular and chemical chaperones on protein folding. Cell Stress Chaperones. 1,109-15. (1996).
28. Xie, Q, Khaoustov, V I, Chung, C. C, Sohn, J, Krishnan. B, Lewis D E & Yoffe B. Effect of tauroursodeoxycholic acid on endoplasmic reticulum stress-induced caspase-12 activation. Hepatology. 36,592-601, (2002).
29. Kaneko, M, & Nomura, Y. ER signaling in unfolded protein response. Life Sci. 74, 199-205, (2003).
30. Wright, J. M, Zeitlin, P. L, Cebotaru, L, Guggino, S. E, & Guggino, W. B. Gene expression profile analysis of 4-phenylbutyrate treatment of IB3-1 bronchial epithelial cell line demonstrates a major influence on heat-shock proteins. Physiol Genomics. 16, 204-11, (2004)
31. De Torres-Zabala, M, Truman, W, Bennet, M. H, Lafforgue, G, Mansfield, J. W, Rodriguez Eaga, P, Bogre, L, & Grant, M. Pseudomonas syringae pv. tomato hijacks the Arabidopsis abscisic acid signalling pathway to cause disease. The EMBO Journal 26, 1434-1443, (2007).
32. Jacobs, A. K, Lipka, V, Burton. R. A, Panstruga. R, Strizhov. N, Schulze-Lefert. P. & Fincher. G. B. An Arabidopsis callose synthase, GSL5, is required for wound and papillary callose formation, Plant Cell 15, 2503-2513 (2003).
33. Schober, M. S, Burton, R. A, Shirley, N. J, Jacobs, A. K, & Fincher, G. B. Analysis of the (1,3)-beta-D-glucan synthase gene family of barley. Phytochemistry. 70, 713-20, (2009).
34 Manjunatha. G, Niranjan-Raj, S, Prashanth. G. N., Deepak. S, Amruthesh K. N, & Shetty, H. S. Nitric oxide is involved in chitosan-induced systemic resistance in pearl millet against downy mildew disease. Pest Manag Sci. 65, 737-43, (2009).
35 Koornneef, A, & Pieterse, C. M. J Cross talk in defense signaling. Plant Physiol. 146, 839-844, (2008).
36. Dickman, M. B, Park, Y. K, Oltersdorf. T, Li, W, Clemente, T, & French, R. Abrogation of disease development in plants expressing animal antiapoptotic genes. Proc Natl Acad Sci U S A, 98, 6957-62, (2001).
37. Kotchoni, S. O & Gachomo, E. W. The reactive oxygen species network pathways: an essential prerequisite for perception of pathogen attack and the acquired disease resistance in plants; J. Biosci. 31, 389-404, (2006).
38. Jones A. Does the plant mitochondrion integrate cellular stress and regulate programmed cell death. Trends Plant Sc, 5, 225-230, (2000).
39. Hammarstrom, P., Wiseman, R. L., Powers, E. T. & Kelly J. W. Prevention of transthyretin amyloid disease by changing protein misfolding energetics. Science 299, 713-716. (2003).
40. Zeitlin, P. L., Diener-West M., Rubenstein R. C., Boyle M. P., Lee C. K. & Brass E. L. Evidence of CFTR function in cystic fibrosis after systemic administration of 4-phenylbutyrate. Mol. Ther. 6, 119-126. (2002).
41. Ashton, N. W, & Cove, D. J. The isolation and preliminary characterisation of auxotrophic and analogue mutants of the moss Physcomitrella patens. Mol Gen Genet 154:87-95, (1977).
42. C. Jacyn Baker, C. J, & Mock, N. M. An improved method for monitoring cell death in cell suspension and leaf disc assays using evans blue. Plant Cell, Tissue and Organ Culture 39, 7-12, (1994).
43. Wright, K. M., Duncan, G. H., Pradel, K. S., Carr, F., Wood, S., Oparka, K. J. & Santa Cruz, S. Analysis of the N gene hypersensitive response induced by a fluorescently tagged tobacco mosaic virus. Plant Physiol. 123, 1375-1386, (2000).
44. Thordal-Christensen, H., Zhang, Z., Wei, Y. & Collinge, D. B. Subcellular localization of H202 in plants. H202 accumulation in papillae and hypersensitive response during the barley powdery mildew interaction. Plant J. 11, 1187-1194, (1997).
46. Bellincampi, D, Dipierro N, Salvi G, Cervone F, & De Lorenzo G. Extracellular H₂O₂ induced by oligogalacturonides is not involved in the inhibition of the auxin-regulated rolB gene expression in tobacco leaf explants. Plant Physiology 122, 1379-1385, (2000)
47. Wolff, S. P. Ferrous ion oxidation in presence of ferric ion indicator xylenol orange for measurement of hydroperoxides. Methods Enzymol. 233, 182-189, (1994).
48. Schlink, K & Reski, R. Preparing High-Quality DNA From Moss (Physcomitrella patens). Plant Molecular Biology Reporter 20, 423a-423f, (2002).
49. Lichtenthaler, H. K. Chlorophyll and carotenoids pigments of photosynthetic brommembranes Methods Enzymol. 18, 350-382, (1987).

While certain of the preferred embodiments of the present invention have been described and specifically exemplified above, it is not intended that the invention be limited to such embodiments. Various modifications may be made thereto without departing from the scope of the present invention, as set forth in the following claims.

What is claimed is:

1. A method for increasing the resistance of a plant or plant cell to a fungus and fungal toxins produced thereby, comprising administration of at least one chaperone selected from the group consisting of 4-phenyl butyric acid (4-PBA) and tauroursodeoxycholic acid (TUDCA), to said plant or surrounding soil, said plant chaperone being effective to suppress fungus induced programmed cell death and reducing the elaboration of toxin from said fungus.

2. The method of claim 1, wherein said fungus induced programmed cell death in said plant cell enhances fungal proliferation on said plant.

3. The method of claim 1, wherein said chaperone is TUDCA or a biologically active derivative thereof.

4. The method of claim 1, wherein said chaperone is 4-PBA or a biologically active derivative thereof.

5. The method of claim 1, wherein said plant is wheat or barley.

6. The method of claim 5, wherein said fungus phytopathogenic.

7. The method of claim 5, wherein said fungus is Fusarium ssp.

8. The method of claim 7, wherein said fungus is Fusarium graminearum and said toxin is a tricothecene toxin.

9. The method of claim 8, wherein the toxin is deoxnivalenol.

10. The method of claim 1, wherein said chaperone is effective to reduce at least one of fungus induced ROS production, altered nuclear morphology, chromatin condensation, and nuclear DNA fragmentation in said plant cell.

11. The method of claim 1, wherein said chaperones are effective to inhibit colonization of a host plant by said fungus but are not toxic or fungicidal when added to fungal cultures.

12. The method of claim 7, wherein said chaperones are effective to inhibit Fusarium head blight.

13. The method according to claim 1 wherein the chaperone is applied to the leaves or stems of the plant.

14. The method according to claim 1 wherein the chaperone is applied to the roots of the plant.

15. The method according to claim 1 wherein the chaperone is applied to the soil and said soil is optionally tested for the presence of said fungus prior to cultivation of said plant therein.

16. The method according to claim 1 wherein the chaperone is applied to the seeds, tubers, or bulbs of the plant.

17. The method according to claim 1 wherein the chaperone is applied pre-emergence.

18. The method according to claim 1, wherein the chaperone is applied post-harvest to plants or plant products.

19. The method according to claim 1, wherein said plant part is selected from the group consisting of seeds, fruits, vegetables, roots, and tubers.
